(19) United States
(12) Patent Application Publication
(10) Pub. No.: US 2012/0230674 A1
(43) Pub. Date: Sep. 13, 2012

(54) Triggers to Fault Information Insertion in Optical Transport Network

(76) Inventors: Catherine Haiyan Yuan, Plano, TX (US); Quang Chan Tieu, Richardson, TX (US); David Solomon, River Vale, NJ (US); Vikas Mittal, Murphy, TX (US); Daniel P. Lyon, Richardson, TX (US)

(21) Appl. No.: 13/044,670

(22) Filed: Mar. 10, 2011

(51) Int. Cl. H04B 10/08; H04L 12/26

(52) U.S. Cl. 398/17; 370/242

(57) ABSTRACT

Systems and methods for triggering fault information insertion in an optical network are disclosed. In accordance with certain embodiments of the present disclosure, a method may include detecting, by a network element, occurrence of an event. The network element may also determine whether the event comprises a triggering fault condition in which fault information is to be communicated. The network element may additionally insert fault information into a data packet. The network element may further communicate the data packet to at least one neighboring network element.

### RELATED APPLICATION

This application is related to co-pending U.S. patent application Ser. No. 12/779,601, filed May 13, 2010, and titled “Identifying Fault Locations in a Network,” which is incorporated by reference herein.

### TECHNICAL FIELD

The present invention relates generally to the field of communication systems and more specifically to insertion of fault information in an optical transport unit in an optical network.

### BACKGROUND OF THE INVENTION

Communication networks are typically configured to detect faults within the networks. Faults may disrupt the traffic transported along the communication networks and cause a loss of communication between nodes in the networks. Communication networks seek to isolate the faults in a timely manner to avoid losses of data and to maintain communication within the network.

### SUMMARY OF THE INVENTION

In accordance with the present disclosure, disadvantages and problems associated with previous techniques for communication of fault information in an optical network may be reduced or eliminated.

In accordance with certain embodiments of the present disclosure, a method may include detecting, by a network element, occurrence of an event. The network element may also determine whether the event comprises a triggering fault condition in which fault information is to be communicated. The network element may additionally insert fault information into a data packet. The network element may further communicate the data packet to at least one neighboring network element.

### BRIEF DESCRIPTION OF THE DRAWINGS

For a more complete understanding of the present disclosure, and the advantages thereof, reference is now made to the following written description taken in conjunction with the accompanying drawings, in which:

FIG. 1 illustrates an example system configured to transmit data within a network, in accordance with embodiments of the present disclosure;

FIG. 2 illustrates a portion of an Optical Data Unit header in an Optical Transport Unit (OTU) frame that may include information that identifies a fault location in a network, in accordance with embodiments of the present disclosure;

FIG. 3 illustrates an example system that may be used to generate data packets including fault information in response to particular triggers within a network, in accordance with embodiments of the present disclosure;

FIGS. 4-6 illustrate tables detailing differentiation of fault information insertion on a low-order ODU or high-order ODU of an Optical Transport Unit frame, and differentiation between backward fault information insertion and forward fault information insertion; and

FIG. 7 illustrates a flow chart of an example method for generating data packets including fault information in response to particular triggers within a network, in accordance with embodiments of the present disclosure.

### DETAILED DESCRIPTION OF THE INVENTION

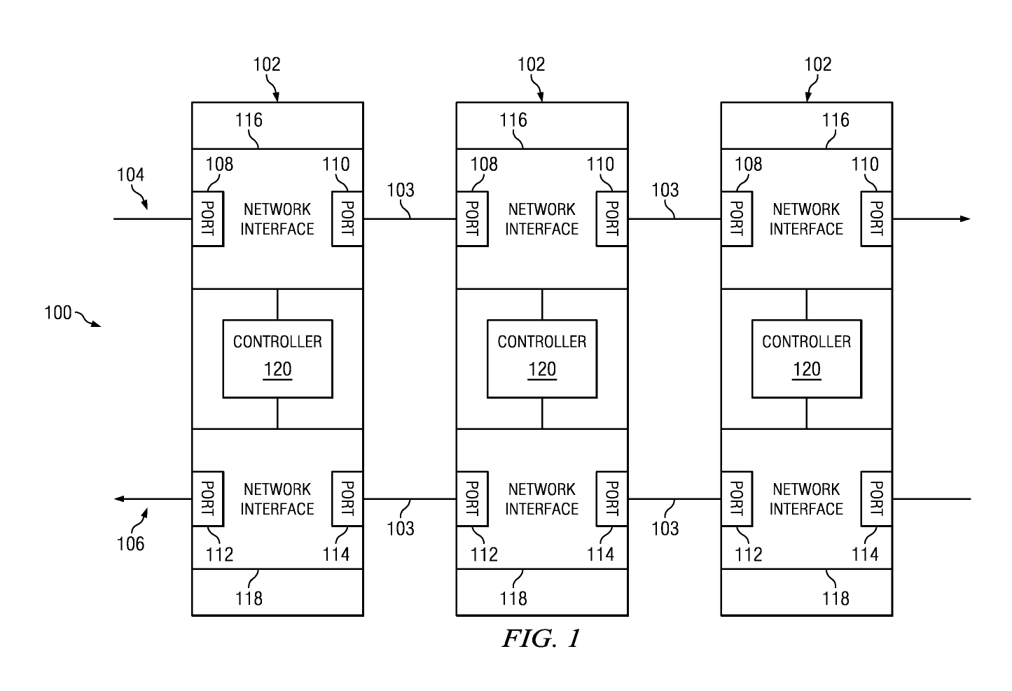

Embodiments of the present disclosure and its advantages are best understood by referring to FIGS. 1-4, where like numbers are used to indicate like and corresponding parts.

FIG. 1 illustrates an embodiment of a system 100 configured to transmit data or signals within a network, in accordance with embodiments of the present disclosure. A communication network may include nodes and transmission media that facilitate communication between nodes within the network. The communication of signals or data between and within nodes may be referred to as “traffic.”

In some embodiments the nodes may be network elements 102 that receive or transmit traffic within the network. Transmission media 103 may be configured to couple network elements 102 and carry traffic between network elements 102.

Faults or errors may occur in transmission media 103 or network elements 102 and the faults may disrupt traffic within the network. Network elements 102 may be configured to detect and report faults to allow isolation and correction of the faults and maintain communication throughout the network.

In certain embodiments, the network may be a communication network. A communication network allows nodes (e.g., network elements 102) to communicate with other nodes. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the proceeding.

In some embodiments, system 100 may comprise an Optical Transport Network (OTN). Traffic may be transmitted by network elements 102 within an OTN according to various protocols such as ITU G.709. Network elements 102 may transmit traffic in data packets or frames known as Optical Transport Unit (OTU) frames.

Traffic may be information transmitted, stored, or sorted within the communication network. Such traffic may comprise optical or electrical signals configured to encode audio, video, textual, or any other suitable data. The data may also be real-time or non-real-time. Traffic may be communicated via any suitable communications protocol, including, without limitation, the Open Systems Interconnection (OSI) standard and Internet Protocol (IP). Additionally, traffic may be structured in any appropriate manner including, but not limited to, being structured in frames, packets, or an unstructured bit stream.

A transmission medium 103 may include any system, device or apparatus configured to couple corresponding ports of nodes (e.g., network elements 102) to each other and transmit traffic between the corresponding ports. For example, a transmission medium 103 may include an optical fiber, a T1 cable, a WiFi signal, a Bluetooth signal, or any other suitable medium.

A link may describe the communicative connection between two adjacent network elements 102. A link may be a physical or logical connection between adjacent nodes. A physical link may include the corresponding ports 108-114 and transmission media 103 that couple adjacent network elements 102 to each other.

In some embodiments, traffic may travel from one network element 102 (a source network element 102) to another network element 102 (a destination network element 102) along an eastward path 104 or a westward path 106. Eastward path 104 and westward path 106 may include the source network element 102, one or more transmission media 103, zero, one, or more intermediate network elements 102 and the destination network element 102.

Although eastward path 104 and westward path 106 are labeled as such, the labels do not mean that the paths are actually travelling east and west. The labels are merely to indicate that traffic on eastward path 104 is being sent in an opposite direction of traffic being sent on westward path 106.

Network elements 102 may be configured to monitor eastward path 104, westward path 106 or both eastward path 104 and westward path 106 for faults or errors. Network elements 102 may be further configured to detect a fault on eastward path 104, westward path 106 or both eastward path 104 and westward path 106. Network elements 102 may be further configured to identify and transmit the location of a fault by identifying network element 102 that detected the fault and the port associated with the network element 102 that detected the fault and associated with the link where the fault may have occurred.

A network element 102 may be any system, apparatus or device that may be configured to route traffic through, to, or from a network. Examples of network elements 102 include routers, switches, reconfigurable optical add-drop multiplexers (ROADMs), wavelength division multiplexers (WDMs), access gateways, intra-connected switch pair, endpoints, softswitch servers, trunk gateways, or a network management system.

Network elements 102 may include various components including, but not limited to, interfaces 116 and 118, ports 108-114, controller 120, logic, memory or other suitable elements.

Interfaces 116 and 118 may include any system, apparatus or device configured to receive input, send output, process the input or output, or perform other suitable operations. Interfaces 116 and 118 may comprise hardware, software or a combination of both. In some embodiments interfaces 116 and 118 may comprise a peripheral interface unit (PIU). Further, although network elements 102 are depicted with two interfaces, network elements 102 may include any number of network interfaces.

Ports 108-114 may include any system, device or apparatus configured to serve as an interface between a corresponding transmission medium and network interfaces 116 and 118. Ports 108-114 may also include the hardware, software or a combination of both configured to facilitate the flow of traffic through ports 108-114 and the transmission medium. Ports 108-114 may comprise physical or logical interfaces. In some embodiments, ports 108-114 may include, but are not limited to an Ethernet port, a USB port, a Firewire port, a WiFi transmitter/receiver, a Bluetooth transmitter/receiver or an OTN port. Although network elements 102 are depicted with four ports, network elements 102 may include any number of ports. Further, although ports 110 and 114, and ports 108 and 112 are depicted as being separate ports, in some embodiments ports 110 and 114 may be a single, bi-directional port, and ports 108 and 112 may be another single, bi-directional port.

Controller 120 may include any system, device or apparatus communicatively coupled to network element 102 and the components within network element 102. Controller 120 may also be configured to control the operations of network element 102. For example, controller 120 may be communicatively coupled to interfaces 116 and 118, or ports 108-114, or both interfaces 116 and 118, and ports 108-114. Controller 120 may to direct the routing of input signals to their appropriate output destination through interfaces 116 and 118 and ports 108-114.

Further, controller 120 may monitor paths and detect faults within the network. As described in greater detail below, controller 120 may be configured to generate data packets including fault information in response to particular events or triggers. Controller 120 may also be configured to generate data packets that identify the location of the faults. Controller 120 may further be configured to direct interfaces 116 and 118 to transmit the data packets to other network elements 102 via ports 108-114, and thus, report the faults to other network elements 102 or a system administrator.

Although network elements 102 are depicted with one controller 120, the disclosure should not be limited to such. Network elements 102 may include multiple controllers 120 that may perform various operations. For example, network interfaces 116 and 118, and ports 108-114 may include controllers 120 that may perform the operations of these components.

Logic within components of network elements 102 may perform the operations of the components within network elements 102. For example, logic may execute instructions to route input signals to their appropriate output destination. Logic may include hardware, software, other logic, or any combination thereof. Logic may be encoded in one or more tangible media and may perform operations when executed by a computer. Certain logic, such as a processor, may manage the operation of a component. Examples of a processor include one or more computers, one or more microprocessors, one or more applications, or other logic.

In particular embodiments, components of network elements 102 may include computer readable media encoded with a computer program, software, computer executable instructions, or instructions capable of being executed by a computer. The computer readable media may perform the operations of the network elements 102 or components within network elements 102. In other embodiments, computer readable media storing a computer program, embodied with a computer program, encoded with a computer program, having a stored computer program or having an encoded computer program may perform the operations of the embodiments.

Components of network elements 102 may also include memory that may comprise one or more tangible, computer-readable, or computer executable storage medium that stores information. Examples of memory include computer memory (e.g., Random Access Memory (RAM), Read Only Memory (ROM)), mass storage media (e.g., a hard disk), removable storage media (e.g., a Compact Disk (CD), a Digital Video Disk (DVD), or a flash memory drive), database or network storage (e.g., a server), or other computer-readable medium.

Modifications, additions, or omissions may be made to system 100 without departing from the scope of the disclosure. For example, although three network elements 102 are depicted, system 100 may include more or fewer than three network elements 102. Further, more or fewer paths may be included in network 100 than eastward and westward paths 104 and 106.

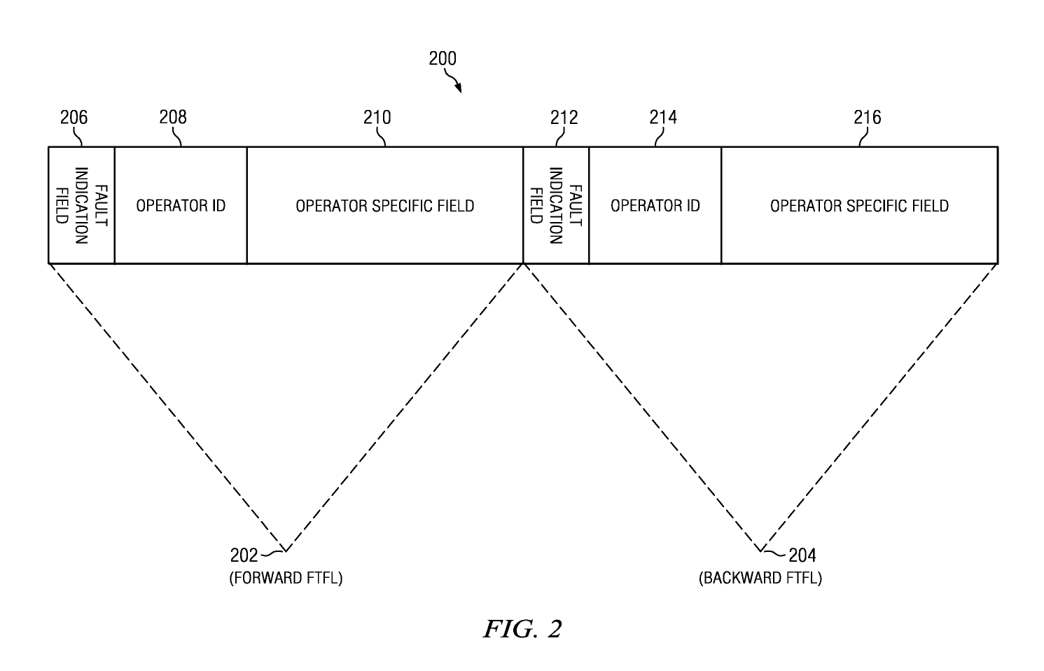

FIG. 2 illustrates a portion of an OTU frame that may include information that identifies a fault location in a network, in accordance with embodiments of the present disclosure. In the present embodiment, the OTU frame may include an Optical Data Unit (ODU) having a Fault Type Fault Location (FTFL) field 200. FTFL field 200 may include a forward FTFL field 202 and a backward FTFL field 204. FTFL field 200 may comprise two hundred fifty-six bytes for carrying information. Forward FTFL field 202 may comprise one hundred twenty-eight bytes and backward FTFL field 204 may also include one hundred twenty-eight bytes. FTFL field 200 may include information related to faults that may occur along paths within a network (e.g., eastward path 104 and westward path 106).

Forward FTFL field 202 may provide the ability to send forward path fault indicators throughout network 100. Backward FTFL field 204 may provide the ability to send backward path fault indicators throughout network 100.

Forward FTFL field 202 may include information associated with faults occurring along the path that the OTU frame is travelling on. Backward FTFL field 204 may include information associated with faults occurring along the path that is opposite to the path that the OTU frame is travelling on.

For example, an FTFL field 200 of an OTU frame travelling along eastward path 104 may include a forward FTFL field 202 that includes fault information associated with eastward path 104. The FTFL field 200 of the OTU frame travelling along eastward path 104 may also include a backward FTFL field 204 that includes fault information associated with westward path 106.

Alternatively, an FTFL field 200 of an OTU frame travelling along westward path 106 may include a forward FTFL field 202 that includes fault information associated with westward path 106. The FTFL field 200 of the OTU frame travelling along westward path 106 may also include a backward FTFL field 204 that includes fault information associated with eastward path 104.

Forward FTFL field 202 and backward FTFL field 204 may include fault indication fields 206 and 212, operator ID fields 208 and 214, and operator specific fields 210 and 216. Fault indication fields 206 and 212 may include fault indication codes that indicate whether a fault has occurred and the type of fault that may occur along the paths within a network. Fault indication codes may include codes found in ITU G.709 such as “signal fail,” “signal degrade,” and “no fault.”

Fault indication fields 206 and 212 may be one byte long and fault indication field 206 may be the first byte of forward FTFL field 202 (byte 0 of FTFL field 200). Fault indication field 212 may be the first byte of backward FTFL field 204 (byte 128 of FTFL field 200).

Forward FTFL field 202 and backward FTFL field 204 may also include operator identification (ID) fields 208 and 214. Operator ID fields 208 and 214 may identify the network operator associated with the network where a fault may have occurred or been detected. Operator ID fields 208 and 214 may include further sub-fields including an international segment field and a national segment field. The international segment field may include a country code (e.g., a three character International Organization for Standardization (ISO) 3166 geographic/political country code (G/PCC)) that identifies the country of the network operator. The national segment field may include an identifier of the network carrier or operator based on a standardization such as an International Telecommunications Union (ITU) carrier code (ICC).

Operator ID fields 208 and 214 comprise nine bytes after the bytes for fault indication fields 206 and 212 (e.g. bytes 1-9 of FTFL field 200 for operator ID field 208 and bytes 129-137 for operator ID field 214).

Forward FTFL field 202 and backward FTFL field 204 may also include operator specific fields 210 and 216. In the present embodiment, operator specific fields 210 and 216 may include additional information related to the location of an error in a network. In one embodiment, operator specific fields 210 and 216 may include information indicating the network element 102 that may have detected the fault. The network element 102 that detected the fault may be identified using a node Target Identifier (“<TID>”) or any other suitable identifier.

Operator specific fields 210 and 216 may further include information indicating a port 108-114 associated with the link where a fault may occur. Ports 108-114 may be identified using a port access identifier (“<ODU AID>”).

Therefore, in some embodiments, operator specific fields 210 and 216 may pinpoint the location of a fault by including network element and port identifiers (e.g., <TID> and <ODU AID>) within operator specific fields 210 and 216. By pinpointing the location of faults, the faults may be isolated quickly and disruption of traffic within a network may be reduced or eliminated.

In some embodiments, the network element that detects a fault may automatically include <TID> and <ODU AID> information in an FTFL field or other suitable data packet. In other embodiments, the operator of a network may determine how to identify the location of a fault in another manner and may insert that identification in operator specific fields 210 and 216, or any other suitable data packet.

Modifications, additions, or omissions may be made to data packet 200 without departing from the scope of the disclosure. For example, operator specific fields 212 and 216 may include more or less information that may pinpoint the location of a fault occurring along a path. Additionally, although FTFL field 200 and its sub-fields are specifically noted as including information indicating the location and type of a fault, any other suitable data packet may also be used.

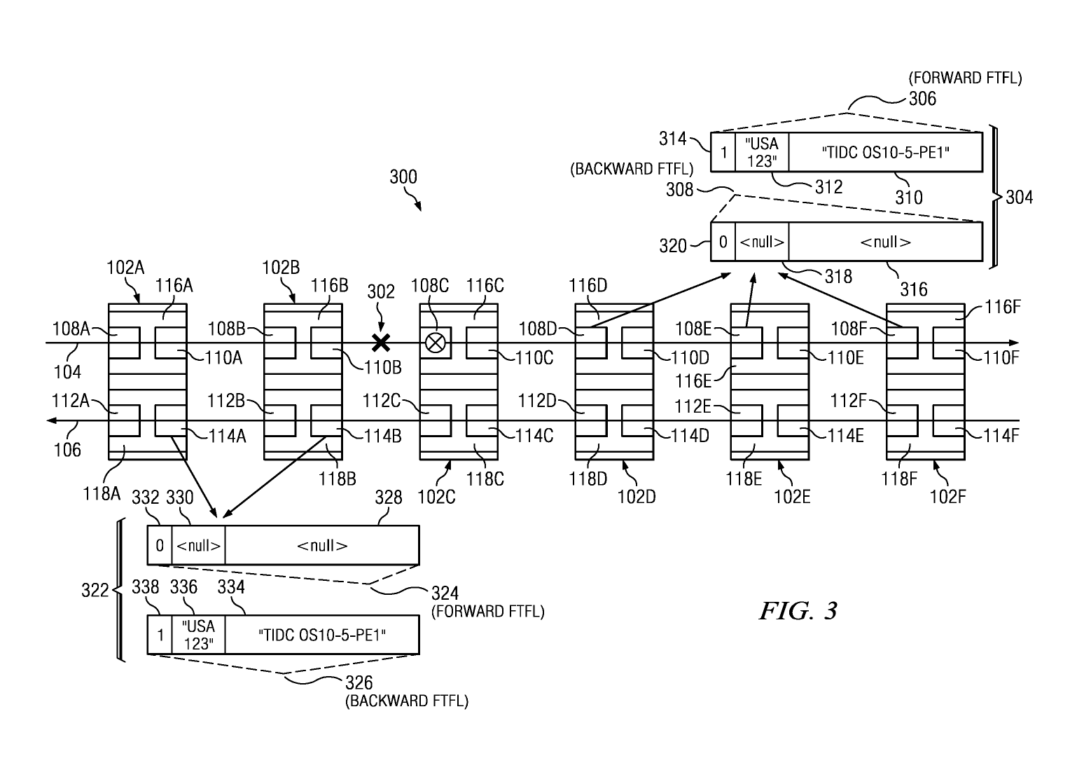

FIG. 3 illustrates an example system 300 that may be used to generate data packets including fault information in response to particular triggers within a network. System 300 may include network elements 102A-102F similar to network elements 102 depicted in FIG. 1. System 300 may also include eastward path 104 and westward path 106. An event 302 may occur in network 300 (e.g., between network elements 102B and 102C on eastward path 104 as shown in FIG. 3). For example, event 302 may occur due to a problem with a transmission medium or port associated with the link between network elements 102B and 102C.

Controller 120 of network element 102C may process event 302 and determine if event 302 is indicative of a fault for which fault information is to be inserted into a data packet. Examples of faults which may serve as triggers for insertion of fault information are discussed in greater detail below.

After determining that event 302 is indicative of a triggering fault, controller 120 of network element 102c may insert fault information into a data packet. For example, the data packet may comprise an OTU frame packet and the fault information may include an FTFL field 304 similar to FTFL field 200 depicted in FIG. 2. After insertion of fault information in response to detection of a triggering fault event, network element 102C may transmit a data packet along eastward path 104 to network element 102D to notify other network elements 102 along eastward path 104 of fault information.

FTFL field 304 may include a forward FTFL field 306 that includes information associated with faults occurring on eastward path 104. FTFL field 304 may also include a backward FTFL field 308 that includes information associated with faults occurring on westward path 106.

As previously noted, forward FTFL field 306 may indicate fault information relating to the path that the OTU frame containing the FTFL field is travelling along. Backward FTFL field 308 may indicate fault information relating to the path opposite to the path that the OTU frame containing the FTFL field is travelling along. In the present embodiment the OTU frame containing FTFL field 304 is travelling along eastward path 104, therefore forward FTFL field 306 may include fault information relating to eastward path 104. Backward FTFL field 308 may include fault information relating to westward path 106 because traffic on westward path 106 may travel in the opposite direction of the OTU frame containing FTFL field 304—which may be travelling on eastward path 104.

Forward FTFL field 306 may include a fault identification field 314 that may identify the type of event 302 that occurred on eastward path 104 (e.g., “signal fail,” “signal degrade,” etc.). Forward FTFL field 306 may further include an operator ID field 312 that identifies the network operator of the network depicted by system 300. Operator ID field 312 may include an international segment identifying the operator's country, and an ICC that identifies the network operator. In the present embodiment, the network operator may be located in the United States and the ICC for the operator may be “123,” therefore, the operator ID field may be “USA123.”

Forward FTFL field 306 may further include an operator specific field 310 that indicates the network element and port associated with event 302. In the present embodiment, operator specific field 310 may identify network element 102C as the network element that detected event 302. Operator specific field 310 may further indicate that port 108C within network element 102C is associated with event 302. Port 108C is associated with the link between network elements 102B and 102C where event 302 occurred and, thus, port 108C may also be associated with event 302. Therefore, operator specific field 310 may pinpoint the location of event 302 on eastward path 104 within network 300.

In the present embodiment operator specific field 310 may identify network element 102C using a <TID> <ODU AID> identifier where the <TID> identifier may identify network element 102C and the <ODU AID> identifier may identify port 108C. For example, the <TID> <ODU AID> identifier for network element 102C and port 108C may be “TIDC OS 10-5-PE1.”

Backward FTFL field 308 may also include a fault identification field 320, an operator ID field 318, and an operator specific field 316 to provide information associated with any faults occurring on westward path 106. In the present example, no faults have occurred on westward path 106, and therefore fields 320, 318 and 316 may be set to “0” or “<null>” to indicate such.

As network element 102D receives FTFL field 304 from network element 102C, network element 102D may send an OTU frame containing FTFL field 304 along eastward path 104 to network element 102E, which may forward FTFL field 304 to network element 102F etc. By receiving FTFL field 304, which includes information indicating that network element 102C and port 108C are associated with event 302, each network element 102 following network element 102C on eastward path 104 may more specifically know the location of event 302 on eastward path 104.

Additionally, after insertion of fault information in response to detection of a triggering fault event (e.g., event 300), network element 102C may transmit a data packet, along westward path 106 to network element 102B to notify other network elements 102 along westward path 106 of any fault information. In the present embodiment, the data packet may comprise an OTU frame that includes an FTFL field 322. FTFL field 322 may include a forward FTFL field 324 that includes information associated with faults occurring on westward path 106. FTFL field 322 may also include a backward FTFL field 326 that includes information associated with faults occurring on eastward path 104.

Forward FTFL field 324 may include fault information related to westward path 106 because the OTU frame containing FTFL field 322 may travel along westward path 106. Backward FTFL field 326 may include fault information related to eastward path 104 because the OTU frame containing FTFL field 322 may travel in a direction opposite of eastward path 104—along westward path 106.

Forward FTFL field 324 may also include a fault identification field 332, an operator ID field 330, and an operator specific field 328 to provide information associated with any faults occurring on westward path 106. In the present example, no faults have occurred on westward path 106, and therefore fields 332, 330, and 328 may be set to “0” or “<null>” to indicate such. Backward FTFL field 326 may include a fault identification field 338 that may identify the type of event 302 that occurred on eastward path 104 (e.g., “signal fail,” “signal degrade,” etc.). Backward FTFL field 326 may further include an operator ID field 336 that includes similar or identical information to that included in operator ID field 312 of forward FTFL field 306 in FTFL field 304.

Backward FTFL field 326 may further include an operator specific field 334 that indicates the network element and port associated with event 302. In the present embodiment, operator specific field 334 may include similar or identical information to that included in operator specific field 310 of forward FTFL field 306 in FTFL field 304.

As network element 102B receives the OTU frame containing FTFL field 322, network element 102B may send an OTU frame containing FTFL field 322 along westward path 106 to network element 102A, which may send an OTU frame containing FTFL field 322 along westward path 106 to other network elements 102. By receiving an OTU frame containing FTFL field 322, which may include information indicating that network element 102C and port 108C are associated with event 302, each network element 102 following network element 102C on westward path 106 may more specifically know the location of event 302 on eastward path 104.

Modifications, additions, or omissions may be made to system 300 without departing from the scope of the disclosure. For example, system 300 may include more than the six network elements 102 depicted or system 300 may include fewer than the six network elements depicted. Further, system 300 may include more or fewer paths than eastward path 104 and westward path 106.

An event that indicates a triggering fault for insertion of fault information in a data packet may include any suitable event. Set forth below are events that may indicate a triggering fault for insertion of fault information at various OTN layers:
frame alignment overhead (FA OH) and completely standardized Optical Channel Transport Unit-k (OTUk) level: loss of signal (LOS), loss of frame (LOS), loss of multiframe (LOM), trail trace identifier (OTUk-TTI), alarm indication signal (OTUk-AIS), bit error rate signal failure (OTUk-BERSF), bit error rate signal degrade (OTUk-BERSD);
Optical Channel Data Unit-k Path Monitoring level: trail trace identifier (ODUkP-TTI), lock (ODUkP-LCK), open connection indication (ODUkP-OCI), alarm indication signal (ODUkP-AIS), bit error rate signal failure (ODUkP-BERSF), payload type mismatch (OPUk-PTM), loss of frame and loss of multiframe (ODUj-LOFLOM), multiplex structure identifier mismatch (ODUj-MSIM), bit error rate signal degrade (ODUkp-BERSD); and
Optical Channel Data Unit-k Tandem Connection Monitoring level: trail trace identifier (ODUkT<i>TTI), lock (ODUkT<i>LCK), open connection indication (ODUkT<i>OCI), alarm indication signal (ODUkT<i>AIS), loss of tandem connection (ODUkT<i>LTC), bit error rate signal failure (ODUkT<i>BERSF), bit error rate signal degrade (ODUkT<i>BERSD).

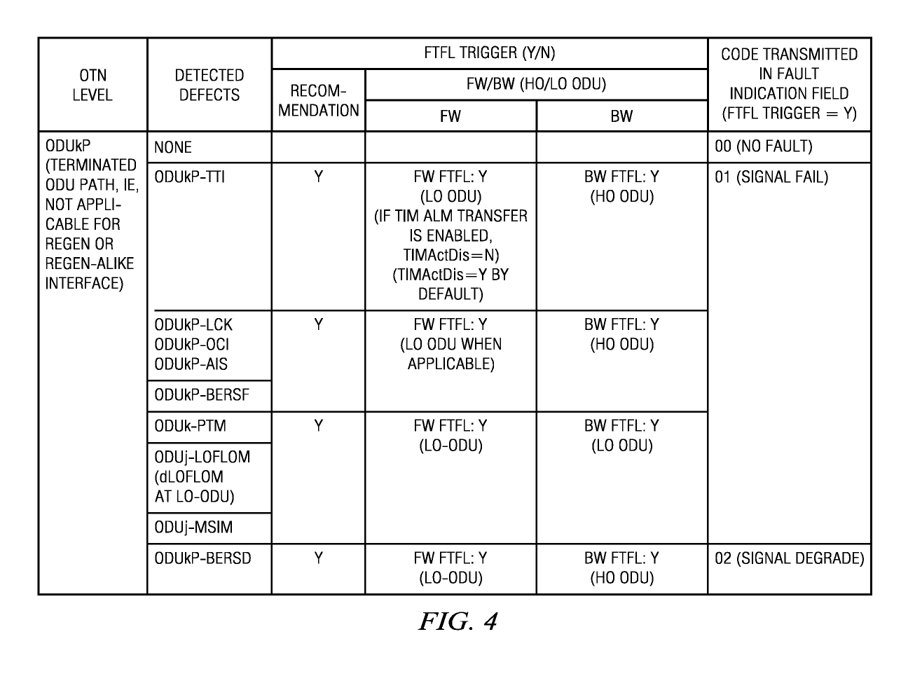

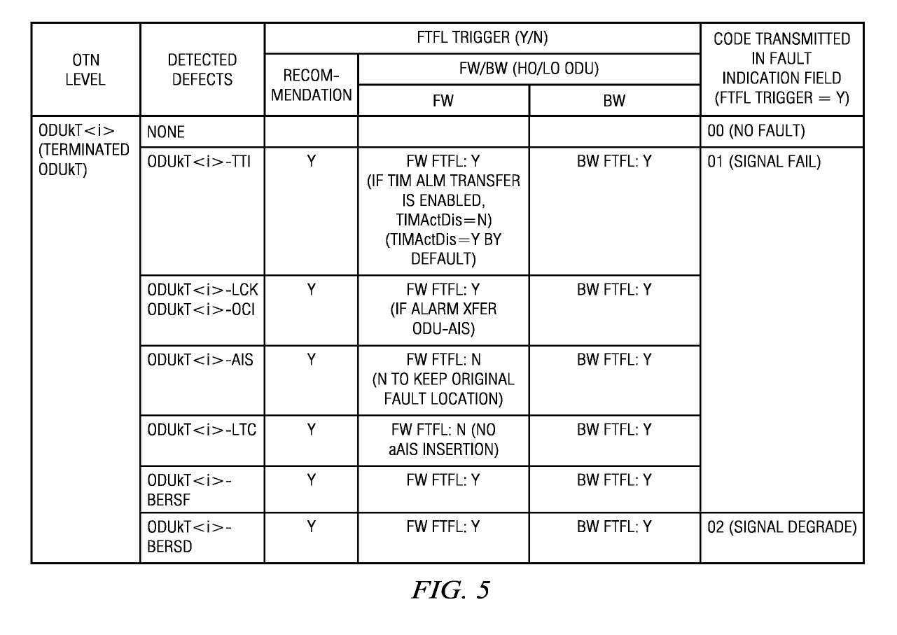

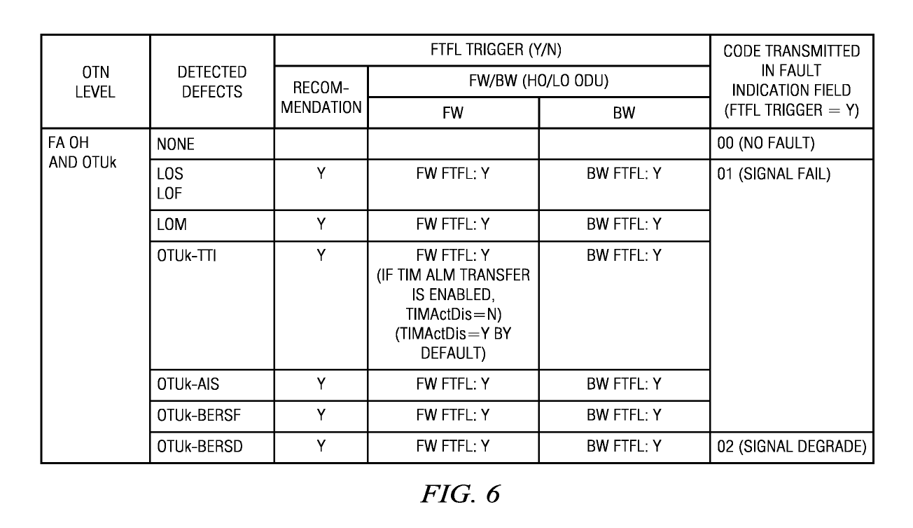

In response to these events, a controller 120 may insert a fault indication code of “signal fail” into a data packet except for bit error rate signal degrade events, in which a “signal grade” fault indication code may be inserted. To further illustrate, tables set forth in FIGS. 4, 5, and 6 detail differentiation of FTFL insertion on a low-order ODU (LO-ODU) or high-order ODU (HO-ODU) of an Optical Transport Unit (OTU) frame, and differentiation between backward FTFL (BW FTFL) insertion and forward FTFL (FW FTFL) insertion. As used in FIGS. 4, 5, and 6, TIM ALM refers to Trail Trace Identifier Mismatch Alarm and TIMActDis refers to Trail trace Identifier Mismatch Consequent Actions Disabled.

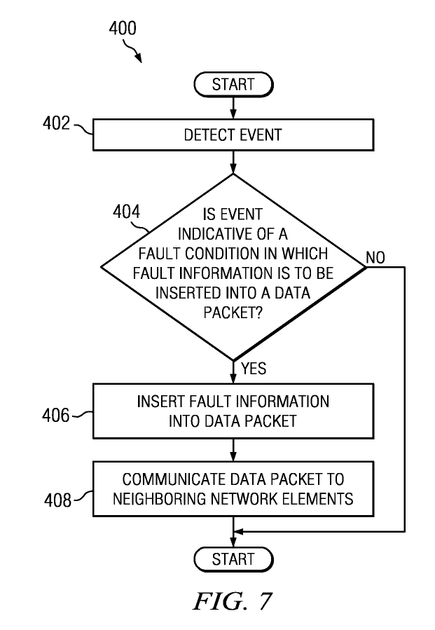

FIG. 7 illustrates a flow chart of an example method 400 for generating data packets including fault information in response to particular triggers within a network, in accordance with embodiments of the present disclosure. According to some embodiments, method 400 may begin at step 402. As noted above, teachings of the present disclosure may be implemented in a variety of configurations of system 100 and/or system 300. As such, the preferred initialization point for method 400 and the order of the steps 402-408 comprising method 400 may depend on the implementation chosen.

At step 402, a controller 120 of a network element 102 may detect an event (e.g., event 102).

At step 404, controller 120 may determine if the detected event is indicative of a fault condition for which fault information is to be inserted into a data packet. If the detected event is indicative of such a fault condition, method 400 may proceed to step 406. Otherwise, method 400 may end.

At step 406, in response to a determination that the detected event is indicative of a fault condition, controller 120 may insert fault information into a data packet. In certain embodiments, such fault information may include FTFL information.

At step 408, network element 102 may communicate the data packet including fault information to neighboring network elements, as described in greater detail above. After completion of step 408, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using system 100, system 300, and/or any other system operable to implement method 400. In certain embodiments, method 400 may be implemented partially or fully in software and/or firmware embodied in memory.

Although the present disclosure and its advantages have been described in detail, it should be understood that various changes, substitutions and alternations can be made herein without departing from the spirit and scope of the disclosure as defined by the following claims.

What is claimed is:

1. A method comprising:
detecting, by a network element, occurrence of an event;
determining, by the network element, whether the event comprises a triggering fault condition in which fault information is to be communicated;
inserting, by the network element, fault information into a data packet; and
communicating the data packet to at least one neighboring network element.

2. The method of claim 1, wherein data packet comprises an Optical Data Unit (ODU) of an Optical Transport Unit (OTU) frame.

3. The method of claim 1, wherein fault information comprises a Forward Fault Type Fault Location (Forward FTFL) associated with an Optical Data Unit (ODU).

4. The method of claim 1, wherein the fault information comprises a Backward Fault Type Fault Location (Backward FTFL) associated with an Optical Data Unit (ODU).

5. The method of claim 1, wherein triggering fault conditions include one or more of the following conditions at a frame alignment overhead completely standardized Optical Channel Transport Unit-k (OTUk) level of a network: loss of signal, loss of frame, loss of multiframe, trail trace identifier, alarm indication signal, bit error rate signal failure, and bit error rate signal degrade.

6. The method of claim 1, wherein triggering fault conditions include one or more of the following conditions at a Optical Channel Data Unit-k Path Monitoring level of a network: loss of frame, trail trace identifier, lock, open connection indication, paytload type mismatch (PTM), multiplex structure identifier (MSIM), alarm indication signal, bit error rate signal failure, and bit error rate signal degrade.

7. The method of claim 1, wherein triggering fault conditions include one or more of the following conditions at a Optical Channel Data Unit-k Tandem Connection Monitoring level of a network: trail trace identifier, lock, open connection indication, alarm indication signal, loss of tandem connection, bit error rate signal failure, and bit error rate signal degrade.

8. A network element comprising a controller configured to:
detect, by a network element, occurrence of an event;
determine, by the network element, whether the event comprises a triggering fault condition in which fault information is to be communicated;
insert, by the network element, fault information into a data packet; and
communicate the data packet to at least one neighboring network element.

9. The network element of claim 8, wherein data packet comprises an Optical Data Unit (ODU) of an Optical Transport Unit (OTU) frame.

10. The network element of claim 8, wherein fault information comprises a Forward Fault Type Fault Location (Forward FTFL) associated with an Optical Data Unit (ODU).

11. The network element of claim 8, wherein the fault information comprises a Backward Fault Type Fault Location (Backward FTFL) associated with an Optical Data Unit (ODU).

12. The network element of claim 8, wherein triggering fault conditions include one or more of the following conditions at a frame alignment overhead completely standardized Optical Channel Transport Unit-k (OTUk) level of a network: loss of signal, loss of frame, loss of multiframe, trail trace identifier, alarm indication signal, bit error rate signal failure, and bit error rate signal degrade.

13. The network element of claim 8, wherein triggering fault conditions include one or more of the following conditions at a Optical Channel Data Unit-k Path Monitoring level of a network: loss of frame, trail trace identifier, lock, open connection indication, payload type mismatch (PTM), multiplex structure identifier (MSIM), alarm indication signal, bit error rate signal failure, and bit error rate signal degrade.

14. The network element of claim 8, wherein triggering fault conditions include one or more of the following conditions at a Optical Channel Data Unit-k Tandem Connection Monitoring level of a network: trail trace identifier, lock, open connection indication, alarm indication signal, loss of tandem connection, bit error rate signal failure, and bit error rate signal degrade.

15. Logic embodied on a non-transitory computer readable medium, the logic configured to, when executed by a processor:
detect, by a network element, occurrence of an event;
determine, by the network element, whether the event comprises a triggering fault condition in which fault information is to be communicated;
insert, by the network element, fault information into a data packet; and
communicate the data packet to at least one neighboring network element.

16. The logic of claim 15, wherein data packet comprises an Optical Data Unit (ODU) of an Optical Transport Unit (OTU) frame.

17. The logic of claim 15, fault information comprises a Forward Fault Type Fault Location (Forward FTFL) associated with an Optical Data Unit (ODU).

18. The logic of claim 15, wherein the fault information comprises a Backward Fault Type Fault Location (Backward FTFL) associated with an Optical Data Unit (ODU).

19. The logic of claim 15, wherein triggering fault conditions include one or more of the following conditions at a frame alignment overhead completely standardized Optical Channel Transport Unit-k (OTUk) level of a network: loss of signal, loss of frame, loss of multiframe, trail trace identifier, alarm indication signal, bit error rate signal failure, and bit error rate signal degrade.

20. The logic of claim 15, wherein triggering fault conditions include one or more of the following conditions at a Optical Channel Data Unit-k Path Monitoring level of a network: loss of frame, trail trace identifier, lock, open connection indication, payload type mismatch (PTM), multiplex structure identifier mismatch (MSIM), alarm indication signal, bit error rate signal failure, and bit error rate signal degrade.

21. The logic of claim 15, wherein triggering fault conditions include one or more of the following conditions at a Optical Channel Data Unit-k Tandem Connection Monitoring level of a network: trail trace identifier, lock, open connection indication, alarm indication signal, loss of tandem connection, bit error rate signal failure, and bit error rate signal degrade.
